(19) United States
(12) Patent Application Publication
(10) Pub. No.: US 2008/0082373 A1
(43) Pub. Date: Apr. 3, 2008

(54) System and method for improved itinerary providing merchant information

(75) Inventors: Lisa Durocher, Warren, NJ (US); Marcella Shinder, New York, NY (US); Krista Stein, New York, NY (US); Jennifer Friedman, New York, NY (US); Jibreel Lockhart, Brooklyn, NY (US); Ajay Singh, Budd Lake, NJ (US)

Correspondence Address: FITZPATRICK CELLA (AMEX), 30 ROCKEFELLER PLAZA, NEW YORK, NY, 10112, US

(73) Assignee: American Express Travel Related Services Co., Inc., New York, NY (US)

(21) Appl. No.: 11/645,596

(22) Filed: Dec. 27, 2006

Related U.S. Application Data
(60) Provisional application No. 60/848,640, filed on Oct. 3, 2006.

(51) Int. Cl. G06Q 10/00

(52) U.S. Cl. 705/6; 705/1

(57) ABSTRACT

Method of preparing an itinerary for a customer traveling to a destination. The method includes the steps of providing on the itinerary reservation information identifying the customer's schedule in relation to at least one of an accommodation, means of transport, and event and providing on the itinerary a listing of merchants local to a destination related to the customer's reservation information. The listed merchants are determined based on their relevance to at least one of the customer's past spending habits and the past spending habits of a group of other customers deemed similar to the customer.

### BACKGROUND OF THE INVENTION

1. Field of the Invention

The present invention generally relates to an itinerary system and method of providing to a traveler an itinerary, which itinerary sets forth travel details (e.g., hotel reservations, airline reservations, etc.) and a customized listing of merchants (e.g., a listing of merchants proximate to the traveler's destination). More preferably, the present invention relates to itineraries in which merchant information is determined based on the proximity of the merchants to the traveler's destination and analysis of financial transaction data from one or more of the traveler's financial transaction instruments and/or financial transaction instruments from other customers deemed similarly situated to the traveler. This is preferably achieved by analysis of past financial transaction data indicative of habits, preferences, and/or trends to tailor the merchant information to the traveler more so then destination information alone.

In addition, the present invention is related to a rules engines which filters data from various sources (e.g., customers' spending patterns, customers' indicated preferences, merchant data, travel requests, etc.) and integrates/analyzes that data to determine pertinent merchant information to be provided with respect to a particular itinerary or related customer tool.

2. Prior Art

Catering to travelers to garner their patronage for vacation and business travel is an important goal of the travel industry.

Typically, vendors/merchants in the travel industry compete for advertising space and other avenues of promotion. Also, it is common for travel service companies and merchants to partner so that the travel service company can direct customers to a partner. This often leads to the customer being provided with the merchant information at or near the time of booking flights, hotel reservations, etc., through the travel service company.

There is, however, room for improvement in methods and systems for providing travelers with pertinent and desirable merchant information.

In this regard, the present inventors have determined that providing such merchant information in connection with (and preferably on) an itinerary would enhance a traveler's consideration of the same, given the likelihood of carrying the itinerary throughout the trip. In addition, the inventors have determined enhanced methods for choosing merchants to be listed on an itinerary. Such improvements go beyond simple partnerships between the merchant and travel service company, and include, as examples, consideration of points-of-sale transactions of the traveler, using traveler profiles, using financial transaction data of the traveler and/or other customers deemed similarly situated to the traveler, etc.

Given the foregoing, what is provided is a system, method and computer program product for providing and/or preparing an improved itinerary in association with customized and context relevant merchant information.

### BRIEF DESCRIPTION OF THE INVENTION

The present invention meets the above-identified needs by providing a system, method, and computer program product for an itinerary system with context relevant merchant information provided therewith.

An advantage of the present invention is that it is/provides, to a customer traveling to a destination, an improved itinerary related to the customer's travel plans. The itinerary indicates reservation information identifying a reservation of the customer for at least one of an accommodation, a means of transport, event, etc. Further, provided in connection with the itinerary is a listing of merchants that preferably are (i) local to the customer's travel destination and (ii) affiliated with an entity issuing the itinerary.

The itinerary may be provided in, at least, a paper format and/or electronic format (including, but not limited to, an email message, text (SMS) message, web page, etc.). When the itinerary is provided in an electronic format, the merchant list may be interactive with links to nested or related documents providing the actual merchant information or additional information related to the merchant information.

Another advantage of the present invention is that it is/provides, to a customer traveling to a destination, an itinerary which indicates reservation information identifying a customer's reservation for travel. The itinerary also includes (or has associated) a listing of merchants that are local to the customer's travel destination. Furthermore, (i) the entity issuing the travel itinerary may be an issuer of financial transaction instruments, (ii) the merchants may be affiliated with the entity in that they accept financial transaction instruments issued by the entity, and (iii) the customer may be a holder of a financial transaction instrument issued by the entity.

With this advantageous embodiment, the entity issuing the itinerary has access to information concerning the financial transactions of the customer and the financial transaction of other customers who may have been patrons of the merchants. Accordingly, the entity can determine the merchants to be listed in connection with the itinerary based on past use of the customer's financial transaction instrument and/or past uses by other customers judged to be similarly situated to the customer to whom the itinerary is to be provided. Thus, a further advantage of the invention is that the listed merchants can be customized to the needs of the customer based not only in proximity to the customer's destination, but a wide range of variables that could indicate that the merchants could be desirable to the customer. Such variables may include popularity of the merchants, similarity to other merchants of which the customer has been a patron, point-of-sale information from the customer's financial transaction instrument, customer surveys/profiles, etc., which data may only be available to the entity issuing the itinerary (e.g., a closed loop system).

In other embodiments, the present invention provides a method of issuing to a customer, traveling to a destination, a travel itinerary related to the customer's travel plans. The method includes a step of preparing the travel itinerary, the travel itinerary indicating reservation information identifying a reservation of the customer for at least one of an accommodation, means of transport, and event. Provided in connection with the travel itinerary is a listing of merchants that are (i) local to the customer's travel destination and (ii) affiliated with an entity that is issuing the itinerary. The method also includes supplying the travel itinerary (and listing, if provided separately) to the customer or customer's agent.

In yet another embodiment, the present invention provides a method of preparing an itinerary for a customer traveling to a destination. The method includes the steps of providing in connection with the itinerary reservation information identifying the customer's schedule in relation to at least one of an accommodation, means of transport, and event, and providing on the itinerary a listing of merchants local to a destination related to the customer's reservation information. The listed merchants are determined based on their relevance to at least one of the customer's past spending habits and the past spending habits of a group of other customers deemed similar to the customer.

In another embodiment, the present invention provides a rules engine, logic database, or other system for filtering and analyzing data. Specifically, the rules engine monitors and filters/extracts information from sources (e.g., databases) having data concerning historical trip data for customers, current trip data for customers, merchant data, customer preferences (as indicated by historical spending habits, spending patterns, etc.), customer/corporate policies (e.g., indications of preferred carriers, hotels, or service providers indicated by customers or corporate policies (for business travelers)), etc. With the extraction and filtering of such data, an itinerary can be prepared as discussed above.

With these advantages of the invention, the itinerary can be properly tailored to include merchant information more likely to be desirable to the particular customer for whom the itinerary is prepared.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary computer system in which the present invention, in an embodiment, would be implemented.

FIG. 2 is a flowchart illustrating an itinerary preparation process according to one embodiment of the present invention.

FIG. 3 is a flowchart illustrating an itinerary preparation process according to another embodiment of the present invention.

FIG. 4 is a flowchart illustrating an itinerary preparation process according to another embodiment of the present invention.

FIG. 5 is a block diagram illustrating the operation of a preferred rules engine according to an embodiment of the present invention.

### DETAILED DESCRIPTION

### I. Overview

The present invention is directed to a system, method and computer program product for preparing in connection with an itinerary customized merchant information pertinent to the customer's travel plans (i.e., itinerary). The present invention is now described in more detail herein in terms of the above exemplary itinerary and preparation of the same. This is for convenience only and is not intended to limit the application of the present invention. In fact, after reading the following description, it will be apparent to one skilled in the relevant art(s) how to implement the following invention in alternative embodiments (e.g., other methods of preparing or providing the described itinerary, etc.).

The terms “user,” “customer,” “traveler,” “agent,” and/or the plural form of these terms are used interchangeably throughout herein to refer to those persons or entities capable of accessing, using, being affected by and/or benefiting from the itinerary tool that the present invention provides, or the agents/representatives of those persons or entities.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, restaurant, retail store, hotel, service provider, an on-line merchant or the like.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument. This application will discuss the preferences of customers, typically based on the customer's use of a financial transaction instrument; but, a more specific description is that the preferences are preferably measured by transaction activity of a given transaction account associated with one or more customers use of a transaction account and transaction instrument should be considered synonymous in most instances.

A financial transaction instrument (FTI) may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader. Discussion of use of an FTI is often used synonymously with use of a transaction account.

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication device, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., a rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄N₅N₆N₇N₈N₉N₁₀N₁₁N₁₂N₁₃N₁₄N₁₅N₁₆
   The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

Preferred embodiments of the present invention are directed to an improved itinerary and associated merchant information for travelers, and methods and systems for preparing and providing such information. In particular, an improved itinerary of the present invention preferably includes a list of one or more merchants, which list is customized for the customer to which the itinerary is provided. Alternatively, the merchant list may be provided in connection with the itinerary such that the list is provided/offered at the time of booking the travel arrangements and/or as a postscript or the like (e.g., sent separate from or after issuance of the itinerary). When provided at the time of booking the travel arrangements (i.e., itinerary), the list may be provided on a computer interface or the like through which the arrangements are booked. For instance, the list may be provided on a web page, when the booking is made online.

The customization or tailoring of the merchant listing to the customer may be centered around the destination of the customer, as set forth in the itinerary (or other details related to the itinerary). For example, the merchant listing may be designed so as to list merchants in proximity to the destination. This may include merchants within a set distance to the hotel at which the customer will be staying, popular merchants in the city to which the customer will be traveling (e.g., by plane, train, or other means), etc. In addition, or alternatively, the merchant listing may be customized based on the merchant type. Different types may include restaurants, entertainment, merchandise, etc. In addition, the types may be divided into sub-categories of such types. For instance, for restaurants, sub-categories may include price range, food type (e.g., steakhouse, Italian, Asian, etc.), and the like. Other categories could include products, services, and sub-categories of the same. For exemplary purposes, restaurant examples will be focused on throughout the specification. But, as will be appreciated by one of ordinary skill in the relevant art(s), the present invention and various embodiments are not limited thereto.

The determination of which merchants are within proximity to a specific geographical location may be accomplished according to specific identification, street addresses, city identities, metropolitan areas, zip codes, counties, and the like. Conventional mapping technologies may be used to achieve these ends, as will be understood by one of ordinary skill in the relevant art(s).

Categorization and sub-categorization of merchants for listing purposes may be achieved by manual classification, existing classifications, industry codes, and the like. The industry codes may be standard industry classification (SIC) codes, which are often assigned to merchants by a governing agency. In other examples the industry codes may be proprietary classifications. Any one of a number of classifications systems may be used to achieve the category breakdowns of the present invention.

The merchant listing provided on (or with) the improved itinerary may include any combination of a number of items of information. For instance, the merchant listing may include the names of the merchants, telephone numbers, addresses, distance from the customers destination, maps, description of the merchants, reviews of the merchants, etc. Furthermore, this information may be provided directly on the itinerary, when in electronic form, or may be provided in areas reachable by the customer through hyperlinks or the like. The hyperlinks may be to other pages having additional information, the merchant's own website, other Internet sites, and the like. While the list may be reached by hyperlinks or the like, the list is considered to be in or on the itinerary, booking tool interface, or other communication, if it is listed directly therein or in a separate area accessed by a link provided therein.

When hyperlinks are provided, it is preferable that the itinerary be provided as a webpage. Of course, the itinerary may be provided in any one of a number of forms. Such forms may include, but are not limited to, paper, web pages, wireless device formats (formats designed for viewing on a cell phone, such as text messages and the like), emails, etc. Furthermore, the itinerary may be provided as a computer program that automatically inserts the relevant information into a customer's electronic calendar or other computer interface.

Furthermore, the merchant listing, while preferably provided in the itinerary, may be provided as a hyperlink of displayed listing at the time of booking (but before issuance of the itinerary). Alternatively, the listing may be provided in a paper, email, text message, other wireless message, web page, or the like separate from the associated itinerary.

In addition to customizing the merchant list based on proximity to destination and categories, it is preferred that additional vetting processes be used to customize the merchant list. This may be achieved in any one of a number of ways. Preferably, a filtering process is used to provide merchants most relevant to the customer's needs or preferences. Many known filtering processes may be adapted for use in connection with the present invention.

That application describes identifying merchants that may be of interest to a customer based on comparison to other similarly situated customers. In particular, overlap is determined with respect to customers frequenting the same merchants to define/identify groups of customers or patterns, and based on the groupings or patterns, additional merchants are identified for others in the group or consistent with the pattern. In preferred embodiments, the overlap is determined by uses of an FTI such as a credit card. Merchants who accept a particular financial transaction instrument are grouped by location and SIC code. Financial transactions between card members and the various merchants are analyzed to identify those merchants with common FTI member patronage, and to further rank merchants within a group that have common patronage among card members. The ranking of similar merchants may be reported to FTI members who have made at least one purchase from a merchant within a defined group or pattern, in order to assist the FTI holder in connection with making purchases at similar merchants.

The relevant merchants may include all merchants accepting the FTI, or merchants that opt into the program. Also, while the filtering may be based on all merchants, but the listed merchants may be limited to those that opt in.

While the above-discussed application generally focuses on overlap of FTI usage, other filtering is possible. Specifically, when traveling to various destinations the traveler may not have common restaurant patronage habits with local FTI holders, inasmuch as the traveler may be visiting the area for the first time. But as would be appreciated by one of ordinary skill in the relevant art(s), the filtering process can be modified to use product codes to match other types of overlapping FTI usage.

One type of filtering/analysis may be based on simple popularity. For instance, the merchants to be listed on a traveler's itinerary may be determined based on the most popular restaurants frequented by FTI holders having the same FTI as the traveler, and within a specified distance of the destination. Specifically, for a traveler staying at a particular hotel and holding a particular FTI, the itinerary may be developed such that the most popular restaurant choices (as determined by transactions at those restaurants by customers having the same FTI) may be determined within a 0.5 mile radius of the traveler's hotel.

Further filtering may be achieved by the type of restaurants (or other merchant), the price range of the restaurants, popularity among other customers who stayed at the same hotel, popularity of customers who stayed at a similar hotel (as determined by price, number of stars, location, etc.), etc. As an example, when a traveler is staying at a particular hotel, the issuer of the FTI which the traveler is using to pay for one or more portions of the travel may analyze usage patterns of previous customers that have stayed at the same hotel or a similar hotel. Based on the filtering, the merchant list for the current traveler may be customized so as to provide the most popular restaurant selections of the previous customers staying at the same or similar type hotel, and within a specified distance from that hotel (or other destination).

For other filtering methods, the provider of the itinerary may select the listed restaurants in accordance with the customer's own previous usage of the FTI. As an example, if the customer has frequented a particular chain restaurant at other destinations around the country, the merchant list may include the local information for that chain restaurant at the traveler's destination. If the traveler frequented Italian restaurants in other cities, the filtering process may focus on Italian restaurants in the destination city.

The filtering may further be broken down by providing merchant information based on previous usage of an FTI (for a similarly situated group or the customer's own patterns) based on price ranges, types, etc. Preferred restaurant types or price ranges may be determined based on the customer's past FTI usage or by a customer profile which the issuer of the FTI or provider of the itinerary may request from the customer. Such a profile includes price ranges of preferred restaurants when traveling on business (or perhaps a per diem mandated by an employer), preferred food type (for instance Japanese verses Italian), entertainment preferences (e.g., live theater, movies, services (e.g., golf, spas, etc.)).

As can be seen from the discussion above, because the issuer of the itinerary is typically also the issuer of the FTI or has access to the data of the issuer of an FTI, a wealth of information to be used in filtering is readily available. Consequently, any one of a number of usage patterns of an FTI of the traveler or of general FTI usage for other customers at the destination (or elsewhere) can be taken into account in customizing the merchant list for the present traveler. Such filtering can be based on merchant popularity, profiles, traveler's usage habits, as well as point-of-sale information for the traveler. With respect to point-of-sale information, certain FTIs allow for collection of data concerning not only the merchant at which a transaction is initiated, but specific information concerning the goods or services obtained by the FTI holder at that merchant. Such point-of-sale information is uniquely available to an FTI issuer for the particular traveler or groups of other customers, across a wide array of merchants. Thus, the traveler's FTI usage at the actual hotel, or past hotels, may be taken into account to determine the traveler's habits or patterns with respect to purchases, to further customize the list. As an example, a traveler that has used the FTI for massages at other hotels during past travels may be provided with a listing of local spas in connection with the itinerary, particularly when the hotel at which the traveler is to be staying does not provide spa services.

As will be appreciated by one of ordinary skill in the relevant art(s), any one of the above-discussed processes or filters for customizing the merchant list may be combined with other filters or other processes to provide a suitable merchant list for inclusion in the travelers itinerary.

In a preferred embodiment, filtering processes are combined in a manner such that the customers of an FTI issuer are divided into groups dictated by common purchasing habits such as patronage of the same merchants, use of similar merchants, purchases in similar price ranges, purchases of similar products, etc. Alternatively, rules engines can identify patterns or overlaps useful in identifying preferences. In preparing an itinerary, the FTI issuer can determine to which group(s) the traveler belongs or patterns within which he falls. The groups or patterns indicate preferences, such that once the group is identified, merchants used by the group (which the customer may not have used) can be identified for potential options for the customer. Thus, the merchant list provided on/with the itinerary may be obtained based on looking for popular choices within the group/pattern at or near the customer's destination. Alternatively, the determination may be made based on the customer's choices of merchants on past trips and determinations as to similar types of merchants at the new destinations.

With the closed loop system provided by an FTI issuer and its various FTI holders, a more detailed analysis may be performed to determine particular merchants that a given traveler may find desirable. Because such depth of information is not readily available to other entities, the FTI issuer is in a unique position to provide improved merchant information that is desirable, pertinent, and useful to a particular traveler. This information can range from overall customer patterns, patterns of the particular traveler, point-of-sale information, and various other information (preferably including what is available to an FTI issuer based on FTI holder transactions).

### II. Process

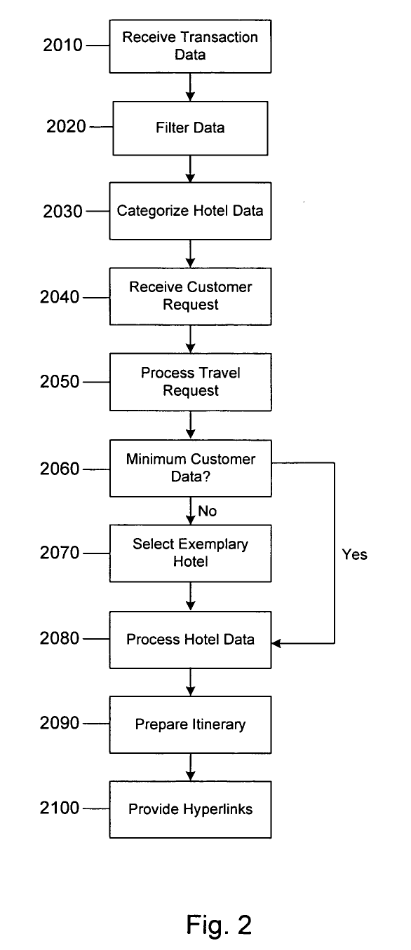

FIG. 2 shows an example method of preparing an itinerary in accordance with one embodiment of the present invention. In step 2010, a computer system receives transaction data from merchants concerning transactions by FTI holders. Such transaction data is routinely forwarded from merchants to issuers of FTI's regarding the daily transactions by FTI holders associated with the corresponding issuer. Thus, the acquisition and processing of such transaction data will be understood by one of ordinary skill in the relevant art(s), particularly credit card companies which receive and process such data on a regular basis. Such data may include the identity of the merchant forwarding the information, the identity of the FTI used to pay for the transaction (i.e., transaction account), the amount of the transaction, the property or service acquired by the FTI holder, etc.

In step 2020, the system filters the data so as to group all data coming from a merchant category which includes hotels and related transactions. Consequently, all transactions by FTI holders at hotels can be filtered from the other transaction data and uniquely stored or identified for further processing. This step also includes the filtering of data not only from the hotel, but also from local merchants during the days at which there are charges at the hotel for that FTI. In step 2030, the system categorizes the hotel data. This may include categorizing the transaction data from different hotels so that each hotel is uniquely identified, and/or grouping the hotels into categories based on their proximity to each other. Sub-categories may include, in addition to proximity information, level information grouping hotels by similar levels whether by review, price, or otherwise.

The categorizing step also includes categorizing usage of the FTI at local merchants during the stay at the hotel. This categorization can include dividing the transactions at local merchants during the hotel stay into categories including restaurant, retail, services, etc. Furthermore, sub-categories may be provided as necessary. For instance, with respect to dining, sub-categories may include price range of the restaurants, type of food served by the restaurants, etc. These divisions into categories may be achieved by known codes, for instance (SIC) codes that may be assigned to merchants by a government agency. Alternatively, the sub-categories can be defined based on data provided by the merchant, investigation by the FTI issuer, reference to restaurant and review guides, or any other conventional means for determining the offerings of a particular merchant.

Preferably, steps 2020 and 2030 are continually performed over time. By doing so, a database of transaction data is accumulated, categorized, and sub-categorized for reference and analysis.

In step 2040, the system receives a request from a customer for travel services. For instance, this may include the booking of an entire trip, booking of transportation alone (bus, train, airline, rental car, etc.), booking of accommodations alone, or booking of activities at a destination, etc. The request for and booking of travel services may be accomplished in any one of a number of conventional manners. For instance, a customer may call a travel agent associated with the company providing the itinerary or managing the transaction data. Alternatively, the booking may be made interactively at a website.

In step 2050, the system (which may include live agents and other known travel booking systems) processes the travel request. For instance, this could include arranging for the airline flights and hotel accommodations and booking and confirming the same. In this example, the travel request includes a hotel request at which a reservation is made for the customer.

In step 2060, it is determined when there is minimum existing customer data for the hotel at which the reservation is made (i.e., is there enough customer data to make valid recommendations for inclusion in the merchant list). This minimum may be set in accordance with design preferences, in order to provide an appropriate sample size for analysis. If there is not a minimum amount of data for the particular hotel, the method proceeds to step 2070, at which a similar hotel in a similar location, having the appropriate sample size, is selected for analysis. After that step is performed, or if it is determined in step 2060 that there is existing customer data for the hotel, the method proceeds to step 2080.

In step 2080, the system processes hotel data in order to prepare the itinerary for the customer with a customized merchant list. This processing includes determining the most popular merchants used by past guests of the hotel determined in step 2060 or 2070. This may include preparing the most popular few merchants used by past guest in different categories. For instance, this processing step may acquire the three most popular restaurant choices for guests of the hotel, three most popular shopping locations for guests of the hotel, and three most popular theater selections by guests of the hotel. As discussed above, the popularity is determined based on acquired data from steps 2020 and 2030, which is based on the use of past customers' FTIs at local merchants and the categorization of such data by the issuer of the FTI.

In step 2090, an itinerary is prepared electronically for the customer, which itinerary includes information concerning the hotel, flight information and the customized merchant listing.

In step 2100, the merchant listing is provided using hyperlinks in the electronic itinerary. Preferably, such hyperlinks are titles of categories, such as “restaurants,” “shopping,” and “theater.” When the customer receives the itinerary, the customer may click on one of the hyperlinks for a category to obtain a listing of the most popular merchants in that category. Further hyperlinks may be provided to information on reviews, maps, detailed description, etc., for those merchants. Alternatively, the hyperlinks may be provided at the time of booking or in a separate electronic message.

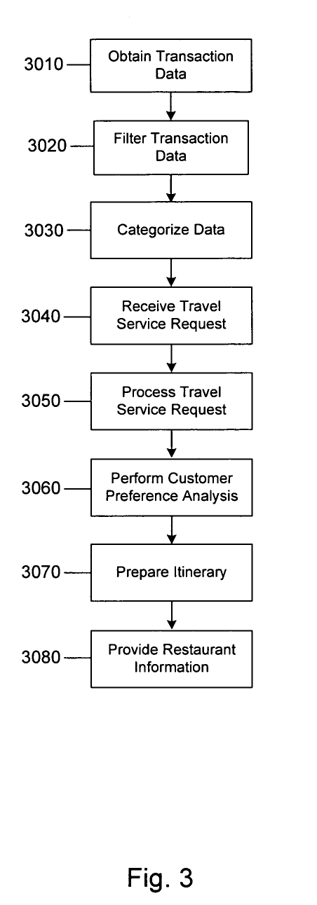

FIG. 3 shows another method according to an embodiment of the present invention. In step 3010, the system obtains transaction data from merchants, in this example, specifically from restaurants. This is achieved in the same or similar manner as discussed above with respect to the method shown in FIG. 2. In step 3020, the system filters transaction data provided by restaurants concerning transaction using one or more specified FTIs. The filtering includes categorizing the restaurants from which data is provided by region. This categorization can be achieved by zip codes for the restaurants, specific addresses (take into account known mapping technologies which may be used to pinpoint restaurant locations), cities or towns in which the restaurants are located, etc. The method shown in FIG. 3 also includes a step of categorizing the data (step 3030). In the categorizing step, the filtered restaurants are divided into categories and sub-categories defined by type of food offered, price range, reviews, etc. In this manner, the restaurants forwarding transaction data are divided into groups which indicate the locations of the restaurants, the type of food which the restaurant serves, the typical price range for dining at the restaurant (or ranges of prices for entrees), rating of the restaurant, and/or other such information to be used in determining whether a customer would be interested in receiving information concerning that restaurant. As discussed above, such categorization information for restaurants can be obtained for the specific purpose of the present invention, or obtained from existing sources.

In step 3040, the system receives a travel service request from a customer. In step 3050, the system processes the travel request. Both of the steps are performed in a manner similar to that discussed above with respect to the method shown in FIG. 2.

In step 3060, a destination/customer preference analysis is performed. Specifically, the system analyzes the preferences of the customer utilizing the travel services, i.e., the customer for which a travel itinerary is to be prepared. This analysis includes analyzing transaction data particular to that customer from past usage of an FTI at restaurants. Specifically, by analyzing past usage of an FTI at restaurants by the customer, preferences and habits may be obtained. For instance, analysis may be performed on the food types preferred by the customer, the price range of restaurants frequented by the customer, etc. Furthermore, this analysis may be performed with respect to usage habits while near the customer's home (as may be determined based on the billing address for the FTI being analyzed) and usage habits while the customer is away. (This may be obtained based on the zip codes in which charges are incurred, or similar method.) Alternatively, or in addition to this analysis, the usage habits may be determined based on a survey provided to the customer. The survey may query the customer based on preferences of restaurants and other merchants, as well as sub-categories within those categories. The survey may be provided to the customer at the inception of issuance of the FTI, at any other times during the customer's relationship with the FTI issuer, and/or at each instance that the customer requests travel related services.

Based on this analysis, destination information can be prepared which provides a restaurant listing for the customer's destination, which relates to the customer's preferences as determined by the customer preference analysis discussed above. For instance, the destination analysis may determine restaurants close to the customers destination which serve the type of food and/or are in the price range which the customer has demonstrated preference for in the past, through use analysis and/or preferences based on survey (or a combination of the two).

In step 3070, an itinerary is prepared for the customer to include travel information (e.g., hotel and transportation information). The itinerary will also have associated therewith one or more merchant listings. The merchant listing will list the merchants determined in step 3060 as being of potential interest to the customer traveling to the destination. Specifically, in step 3080, the issuer of the itinerary provides the six most popular restaurants in proximity to the destination (e.g., hotel listed on the itinerary) matching the user's preferences.

In this embodiment, the itinerary is provided in a text format which lists the relevant information for the accommodations and transportation and, perhaps, the merchants. Specifically, with respect to the six most popular restaurants, the text indicates the name of the restaurant, the address, the telephone number, and potentially other information which may include description, review, web address, etc. The itinerary and/or list may be provided by mail, fax, email, etc., for printing or storing.

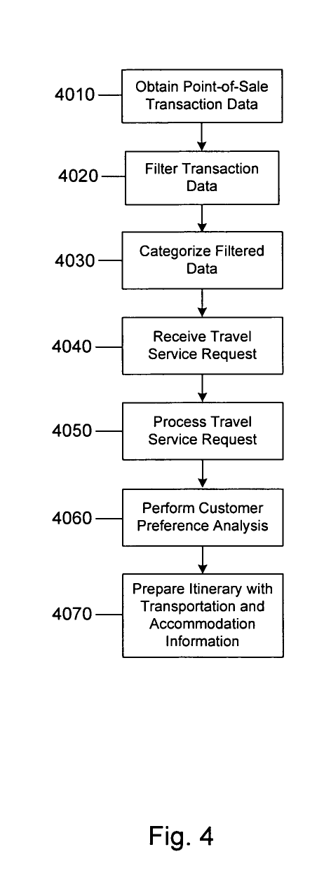

FIG. 4 shows yet another method of preparing an itinerary in accordance with an embodiment of the present invention. In this method, however, point-of-sale information is used to customize the merchant list.

In step 4010, transaction data is obtained from merchants for various customers. This step is similar to corresponding steps performed in the methods discussed with respect to FIGS. 2 and 3; however, in this method, point-of-sale information is also obtained. Often, transaction data from a merchant merely includes identity of the merchant, identity of the FTI holder (or transaction account), and the total cost of the transaction. Thus, there is no specific breakdown as to the item or items obtained from the merchant. In other systems, a more involved partnership between merchants and the FTI issuer in results in additional data being provided from the merchant to the FTI issuer. Specifically, the merchant may include specific point-of-sale information regarding the transaction with the customer. For instance, when the merchant is a hotel, rather than just the total of the charges accumulated during the customer's stay at the hotel, the transaction data may include the identity of specific purchases during that stay. Such purchases may include the charge for accommodations, services from a spa located at the hotel, dining charges (in room or at restaurants within the hotel), gift shop purchases, etc. At merchants that provide retail shopping, the point-of-sale information may include, the actual goods or categories of goods which the customer purchased. For instance, the point-of-sale information from the retailer may indicate that the goods purchased include music CDs, books, clothes, art work, etc. Thus, the receive of transaction data can obtain a more detailed view of the customers spending habits based on the point-of-sale information.

In step 4020, the transaction data is filtered. This step can be performed in a manner similar to that discussed above with respect to the methods shown in FIGS. 2 and 3. In addition, however, the point-of-sale data can also be filtered (i.e., identified) such that, other than just filtering for merchant types, specific purchases from various merchants can also be filtered and analyzed. In step 4030, the filtered data can be categorized. The categories may include music purchases, book purchases, electronic purchases, etc. Thus, the FTI issuer can determine not only the types of merchants preferred by the customer, but the types of products preferred by the customer. This may provide an additional level of detail when purchases are made from merchants with overlapping business models. For instance, certain merchants may be listed as book stores, but the customer's actions may be focused on the purchase of music CDs from those book stores. Thus, the point-of-sale information may indicate specific product types which are preferred by the customer.

In step 4040, the system receives a travel service request. In step 4050, the system processes the travel service request and prepares the necessary reservations, in a manner similar to that discussed above. In step 4060, the system performs a destination/customer preference analysis. In addition to analysis discussed above in the other methods, this method further includes analysis of the point-of-sale information for the customer requesting the travel service. Consequently, merchants to be included in the merchant listing are determined based on proximity to the destination and relevance to past spending habits of the customer with respect to specific products. For instance, if the point-of-sale information has indicated regular purchases of music CDs, the analysis may include determination of the closest store selling music CDs at the customer's destination. If the point-of-sale information indicates that the customer has used the concierge service at other hotels to obtain concert or theater tickets, the merchant listing may be prepared so as to include one or more listings for local concerts and/or theater events.

In step 4070, an itinerary is prepared for the customer with the transportation and accommodation information, as well as a merchant list customized based on the analyzed point-of-sale information for the particular customer for which the itinerary has been prepared.

### III. Operating Logic

The filtering or extraction of data for use in preparing the itinerary may be performed in any number of ways. Preferably, a rules engine or other logic will be implemented to filter and extract the necessary information from existing sources. The software for defining the rules engine or other logic may be formed in any number of ways, as will be appreciated by one of ordinary skill in the art. In addition, the source data is preferably information already received and organized by an FTI issuer (or other entities). For instance, the information may include traveler preferences entered into databases. Such traveler preferences may include corporate policy statements for business travelers. For instance, for business travelers, the business travelers' company may have preferred carriers or hotels which are to be used, if possible. In addition, the information may include merchant data compiled by the FTI issuer, provided in existing compilations, provided to the FTI issuer from merchants interested in being included in the system, etc. Furthermore, there may be existing databases containing data on the past spending patterns/habits of customers using the FTI. Of course, the information may include the actual trip data for a particular travel request provided by a customer.

Each of these different sets of data/information may be provided in different formats and in different databases. In particular, some of the data may be provided separate from the itinerary system for unrelated purposes, but may also prove useful in preparing the itinerary. Thus, the invention may take the form of a rules engine for extracting, filtering, analyzing, etc., data from the different sources. Consequently, existing information from various databases within the FTI issuer (and databases to which the FTI issuer may gain access) can be drawn from to gather information useful in preparing the itinerary or identifying useful merchant information pertinent to a particular travel request.

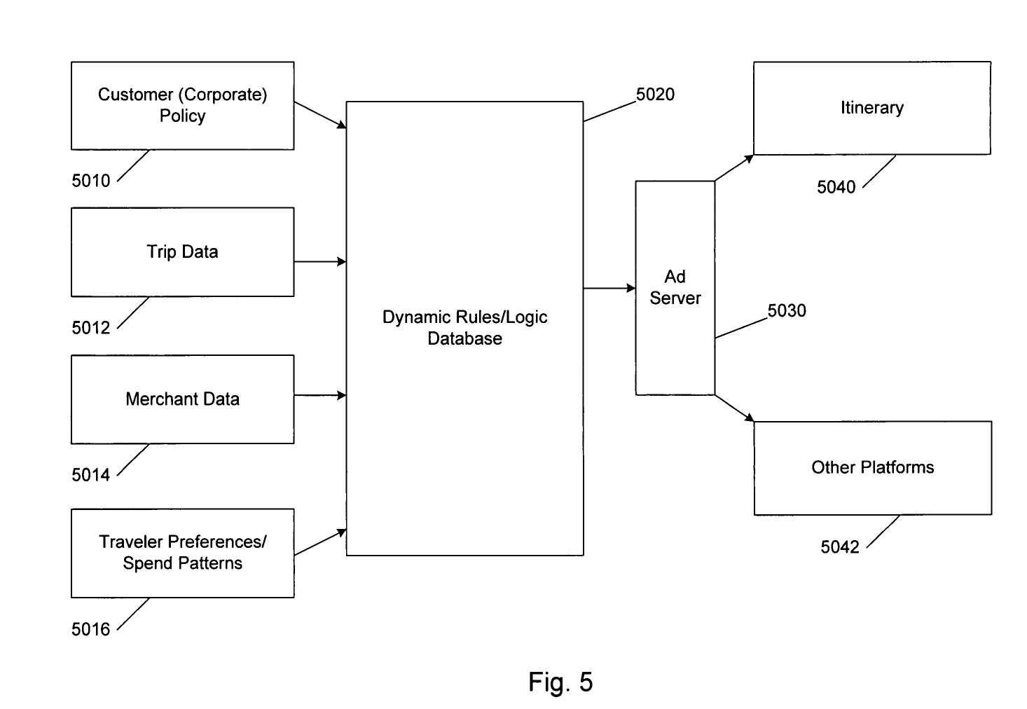

FIG. 5 is a diagram illustrating the general architecture of such a system.

In FIG. 5, there are four separate data sources (e.g., databases), including a database containing customer (corporate) policy information 5010, a database containing current and historical trip data 5012, a database containing merchant data 5014, and a database containing traveler preferences/spending patterns 5016. A dynamic rules database 5020 includes software defining the necessary rules engine to identify and extract relevant information from databases 5010, 5012, 5014, and 5016. Dynamic rules database 5020 extracts the relevant information and filter/analyzes the extracted data to obtain information pertinent to merchant placement. Specifically, dynamic rules database 5020 uses the information in order to identify which merchant listings should be provided to a particular traveler. This helps both the traveler, in receiving the most useful information, and the merchant in getting information or advertising to targeted customer groups. Thus, the system may be used to provide an advertisement targeting system for merchants, such that they can provide not just general advertising, but also specifically targeted advertisements to particular customers most likely to be interested in the related product/service.

Once dynamic rules database 5020 performs the necessary analysis, it selects the proper advertisements or other merchant information from ad server 5030. Thus, the merchant information in ad server 5030 is extracted and provided to the customer. Such information is provided to the customer either in the form of the itinerary 5040, or other platforms 5042, which may include online booking tools or the like.

### IV. Example Implementations

The present invention may be implemented using hardware, software or a combination thereof and may be implemented in one or more computer systems or other processing systems. However, the manipulations performed by the present invention were often referred to in terms, such as determining or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

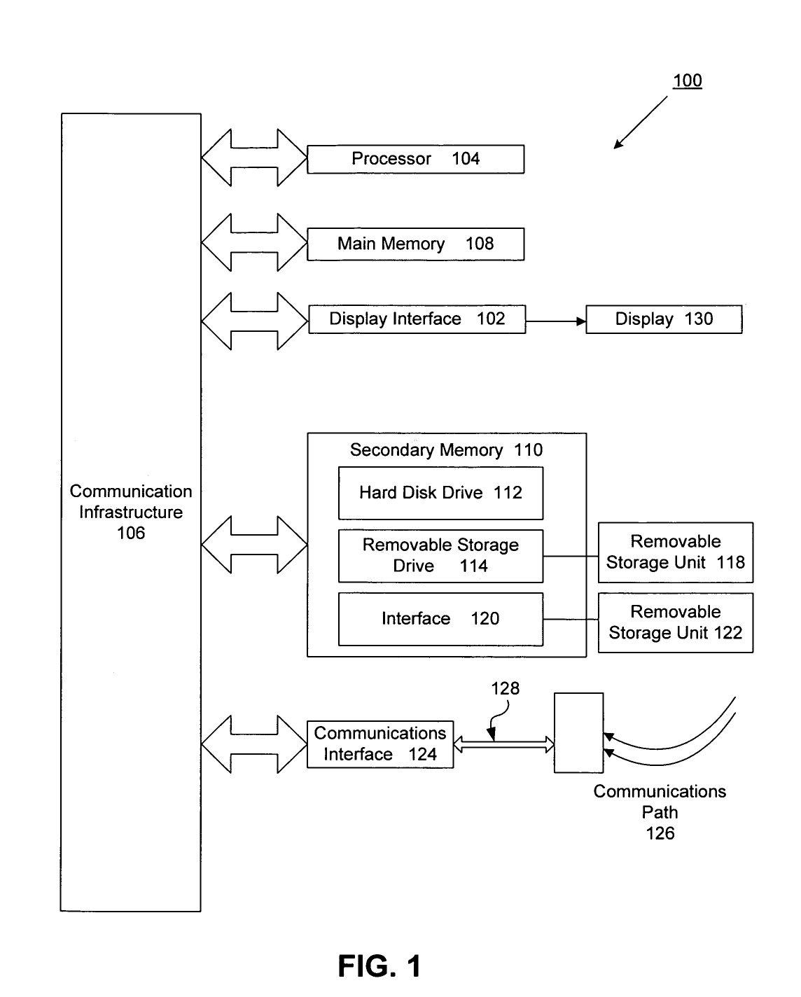

In fact, in one embodiment, the invention is directed toward one or more computer systems capable of carrying out the functionality described herein. An example of a computer system 100 is shown in FIG. 1.

The computer system 100 includes one or more processors, such as processor 104. The processor 104 is connected to a communication infrastructure 106 (e.g., a communications bus, cross-over bar, or network). Processor 104 may perform many of the filtering, analyzing, and/or categorizing functions discussed above, which functions may overlap in application. Various software embodiments are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on the display unit 130.

Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well known manner. Removable storage unit 118 represents a floppy disk, magnetic tape, optical disk, etc. which is read by and written to by removable storage drive 114. As will be appreciated, the removable storage unit 118 includes a computer usable storage medium having stored therein computer software and/or data. The various memories may be used to store transaction data obtained from merchants and/or customer profiles indicative of the customer's preferences.

In alternative embodiments, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface N24 are in the form of signals 128 which may be electronic, electromagnetic, optical or other signals capable of being received by communications interface 124. These signals 128 are provided to communications interface 124 via a communications path (e.g., channel) 126. This channel 126 carries signals 128 and may be implemented using wire or cable, fiber optics, a telephone line, a cellular link, a radio frequency (RF) link and other communications channels.

The communications systems may be used to both communicate with merchants in connection with financial transaction information, and with customers in connection with receiving travel requests and providing itineraries based on those requests.

In this document, the terms “computer program medium” and “computer usable medium” are used to generally refer to media such as removable storage drive 114, a hard disk installed in hard disk drive 112, and signals 128. These computer program products provide software to computer system 100. The invention is directed to such computer program products. In particular, programs may form the basis of this invention by operating various steps associated with embodiments of the present invention, including, but not limited to, receiving and processing financial transaction data, categorizing financial transaction data, processing travel requests, analyzing data in connection with providing a customized merchant list, etc.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 104 to perform the features of the present invention. Accordingly, such computer programs represent controllers of the computer system 100.

In an embodiment where the invention is implemented using software, the software may be stored in a computer program product and loaded into computer system 100 using removable storage drive 114, hard drive 112 or communications interface 124. The control logic (software), when executed by the processor 104, causes the processor 104 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents. In particular, while much of filtering discussed above is based on information from FTI transactions, it is not required that FTI analysis or usage be used in embodiments of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

We claim:

1. A method of issuing a customer, traveling to a destination, a travel itinerary related to the customer's travel plans and a list of merchants, the method comprising the steps of:
preparing the travel itinerary, the travel itinerary indicating reservation information identifying a reservation of the customer for at least one of an accommodation and a means of transport;
identifying merchants local to the customer's travel destination;
including, in connection with the travel itinerary, the list of the merchants local to the customer's travel destination; and
supplying the travel itinerary and list of merchants to the customer.

2. The method according to claim 1, wherein the travel itinerary is provided in an electronic format, and the method further comprises a step of providing the listing of merchants so as to include hyperlinks in the itinerary to at least one of maps, reviews, and descriptions related to the merchants.

3. The method according to claim 1, further comprising steps of:
receiving from the customer a user profile indicating at least one preference of the customer; and
determining which merchants to list in connection with the itinerary, from among a predetermined set of merchants who are local to the customer's travel destination, based on the customer's preferences indicated in the profile.

4. The method according to claim 1, wherein the reservation information includes information related to an accommodation at which the customer will stay, and the listed merchants have places of business proximate to the accommodation.

5. The method according to claim 1, wherein the merchant list is provided in connection with the itinerary in that it is provided in at least one of (i) the itinerary itself, (ii) an interface used to book the travel itinerary, and (iii) a communication to the customer separate from the itinerary.

6. The method according to claim 1, further comprising a step of determining which merchants to list on the itinerary based on popularity of the merchants, as ascertained based on past use of financial transaction instruments at those merchants.

7. The method according to claim 1, further comprising a step of determining which merchants to list on the itinerary based on point-of-sale information of a financial transaction instrument used by the customer.

8. The method according to claim 1, further comprising a step of determining which merchants to list on the itinerary based on analysis of past usage of the a financial transaction instrument used by the customer.

9. The method according to claim 8, wherein the merchants are restaurants, and the analysis performed in the determining step includes analysis of at least one of pricing and food categories of restaurants, at which the financial transaction instrument used by the customer has been used in the past.

10. The method according to claim 1, further comprising a step of determining which merchants to list on the itinerary based on past patterns of use of financial transaction instruments issued and tracked by the entity.

11. The method according to claim 10, wherein the past patterns of use are based on past use of financial transaction instruments held by a group of users similarly situated to the customer.

12. The method according to claim 11, wherein the customer is deemed similarly situated to the group of users if the customer is staying at an accommodation used by the group.

13. The method according to claim 5, wherein the list of merchants is provided as a list of categories of merchants and the actual identities of particular merchants are provided in sub-listings accessible by the customer.

14. A method of issuing an entity a travel itinerary and list of merchants, the method comprising the steps of:
monitoring various customers' uses of their financial transaction instruments at merchants in a designated area;
categorizing and recording identities of the merchants from the monitoring step, at which the customers use their financial transaction instruments;
receiving a request for travel arrangements from the entity, wherein a destination of the travel is proximate to the designated area;
processing the request for travel arrangements received in the receiving step;
preparing an itinerary setting forth the travel arrangements;
including, in connection with the itinerary, the list of merchants selected from at least one category from the categorizing step; and
providing the itinerary and the list of merchants to the entity.

15. The method according to claim 14, wherein the merchants to be included in the list are selected based on identified preferences of the entity.

16. The method according to claim 15, wherein the preferences are determined based on analysis of the entity's past use of a financial transaction instrument.

17. A computer program product comprising a computer usable medium having control logic stored therein for a causing a computer to perform a method of issuing an customer a travel itinerary setting forth travel arrangements, the control logic comprising the steps of:
first computer readable program code means for causing the computer to obtain a list of merchants located in a designated area;
second computer readable program code means for enabling the computer to receive a request from the customer for travel arrangements to a destination proximate to the designated area;
third computer readable program code means for causing the computer to prepare the travel arrangements and itinerary based on the request received in the receiving step;
fourth computer readable program code means for causing the computer to include in connection with the travel itinerary names of merchants from the list of merchants from the obtaining step; and
fifth computer readable program code means for causing the computer to provide the travel itinerary to the customer.

18. The computer readable program product of claim 17, wherein the names of merchants from the including step are selected based on identified preferences of the customer.

19. The computer readable program product of claim 18, wherein the preferences are identified based on past purchases by the customer using a financial transaction instrument.

20. The computer readable program product of claim 17, wherein (i) merchants in the obtaining step are divided into categories; (ii) the itinerary is provided in an interactive, electronic form; and (iii) the categories are listed on the itinerary such that the customer can select a category to obtain names of merchants from the selected category.
